(19) United States
(12) Patent Application Publication
(10) Pub. No.: US 2012/0236082 A1
(43) Pub. Date: Sep. 20, 2012

(54) LIQUID EJECTING HEAD, LIQUID EJECTING APPARATUS, AND MANUFACTURING METHOD OF LIQUID EJECTING HEAD

(75) Inventor: Fujio Akahane, Suwa-shi (JP)

(73) Assignee: SEIKO EPSON CORPORATION, Shinjuku-ku (JP)

(21) Appl. No.: 13/420,429

(22) Filed: Mar. 14, 2012

(30) Foreign Application Priority Data
Mar. 17, 2011 (JP) 2011-059938

(51) Int. Cl. B41J 2/045; B23P 17/00

(52) U.S. Cl. 347/68; 29/890.09

(57) ABSTRACT

A case member includes a first surface and a second surface which have different heights that are adhered to a head main body, that is, another member, and an absorption member that is made of a material having elasticity and absorbs an adhesive is interposed between the second surface and a protection substrate while the first surface is adhered to a communication plate.

This application claims a priority to Japanese Patent Application No. 2011-059938 filed on Mar. 17, 2011 which is hereby expressly incorporated by reference herein in its entirety.

### BACKGROUND

1. Technical Field

The present invention relates to a liquid ejecting head and a liquid ejecting apparatus which may eject liquid from a nozzle, and a manufacturing method of the liquid ejecting head, and more particularly, to an ink jet recording head and an ink jet recording apparatus which ejects ink as liquid, and a manufacturing method of the ink jet recording head.

2. Related Art

As an example of an ink jet recording head that is a representative example may be provided of a liquid ejecting head for ejecting liquid droplets, an ink jet recording head that includes a pressure generating chamber communicating with a nozzle, and a piezoelectric actuator provided to face the pressure generating chamber, and generates a variation in the pressure within the pressure generating chamber through the displacement of the piezoelectric actuator to thereby eject ink droplets from the nozzle.

Diverse structures of the above described ink jet recording head have been suggested, however, in general, a plurality of members is fixed by an adhesive, or the like (for example, see Japanese Patent No. 3402349).

In the structure in which the plurality of members is joined by an adhesive, a single member may be joined in a plurality of joint surfaces having different heights (not the same plane). In this case, from the viewpoint of component tolerance, a gap is always formed except for a single surface which substantially abuts. The gap is generally sealed by the adhesive.

However, when the gap is relatively large, two members are not firmly joined only by sealing the gap using the adhesive. In addition, in this case, more adhesive than usual is coated on the joint surface so that the gap is reliably filled with the adhesive. Thus, excessive adhesive may be extruded into a flow channel, so that the flow channel is by the extruded adhesive, or adhesion or stagnation of bubbles may occur. The gap may be significantly reduced, for example, by increasing machining accuracy of components, however, the costs significantly increase.

Further, the above described problems may also exist in a liquid ejecting head that ejects liquids other than ink as well as an ink jet recording head that ejects ink.

### SUMMARY

An advantage of some aspects of the invention is to provide a liquid ejecting head and a liquid ejecting apparatus which may firmly join respective components while preventing an increase in costs, and a manufacturing method of the liquid ejecting head.

According to an aspect of the invention, there is provided a liquid ejecting head, including: a head main body that includes a flow channel forming member in which a liquid flow channel having a pressure generating chamber communicating with a nozzle ejecting liquid is formed; a pressure generating unit that is provided in an opposite surface side of the nozzle of the head main body, and generates a pressure change in liquid within the pressure generating chamber; and a case member that is fixed in the opposite surface side of the nozzle of the head main body, wherein any one from among the head main body, the pressure generating unit, and the case member is adhered to at least one other member, and has a first surface and a second surface in which a height of a joint surface in an ejection direction of the liquid is different, the first surface is adhered to the other member, and an absorption member that is made of an elastic material and absorbs an adhesive is interposed between the second surface and the other member. In the above described invention, it is possible to firmly join respective members, thereby suppressing a significant increase in costs.

Here, when at least a part of a joint portion on the second surface is in contact with the liquid flow channel, the outflow of the adhesive to the flow channel may be effectively suppressed.

For example, the head main body may include a flow channel forming substrate that has the pressure generating chamber, a nozzle plate that has the nozzle and is joined to one surface side of the flow channel forming member, and a protection substrate that is joined to another surface side of the flow channel forming substrate to protect the pressure generating unit provided on the flow channel forming substrate, the case member may include the first surface adhered to the nozzle plate and the second surface adhered to the protection substrate, and the absorption member may be interposed between the case member and the protection substrate. In the case of this configuration, it is possible to firmly join the protection substrate constituting the head main body, and the case member.

Also, in the case of this configuration, in the case member, a through hole that passes through the case member and opens on the second surface may be provided. As a result, the adhesive may be absorbed in the absorption member through the through hole while the absorption member is interposed between the case member and the protection substrate.

Also, for example, the pressure generating unit may include a piezoelectric actuator of which a front end surface abuts on the head main body, and a fixing plate that is fixed to the case member while supporting a base end side of the piezoelectric actuator, and also include the first surface in which the piezoelectric actuator is adhered to the head main body, and the second surface in which the fixing plate is adhered to the case member, and the absorption member may be interposed between the fixing plate and the case member. In the case of this configuration, it is possible to firmly join the fixing plate constituting the pressure generating unit and the case member.

According to another aspect of the invention, there is provided a liquid ejecting apparatus that includes the above described liquid ejecting head. In the above described invention, it is possible to realize the liquid ejecting apparatus with improved durability and reliability of the head.

According to still another aspect of the invention, there is provided a manufacturing method of a liquid ejecting head that includes: a head main body that includes a flow channel forming member in which a liquid flow channel having a pressure generating chamber communicating with a nozzle ejecting liquid is formed; a pressure generating unit that generates a pressure change in liquid within the pressure generating chamber; and a case member that is fixed in the opposite surface side of the nozzle of the head main body, wherein any one from among the head main body, the pressure generating unit, and the case member is adhered to at least one other member, and has a first surface and a second surface in which the height of a joint surface in the ejection direction of the liquid is different, the manufacturing method, including: abutting and adhering the first surface to the other member; and adhering the second surface to the other member by disposing, in a gap between the second surface and the other member, an absorption member that is made of a material having elasticity and absorbing liquid, and by absorbing an adhesive using the absorption member. In the above described invention, it is possible to firmly join respective members, thereby suppressing a significant increase in costs.

### BRIEF DESCRIPTION OF THE DRAWINGS

The invention will be described with reference to the accompanying drawings, wherein like numbers reference like elements.

FIG. 1 is an exploded perspective view illustrating a recording head relating to embodiment 1;

FIGS. 2A and 2B are cross-sectional views illustrating a recording head relating to embodiment 1;

FIGS. 3A and 3B are cross-sectional views illustrating a manufacturing method of a recording head relating to embodiment 1;

FIG. 4 is a cross-sectional view illustrating a modification example of a recording head relating to embodiment 1;

FIGS. 5A and 5B are cross-sectional views illustrating a recording head relating to embodiment 2;

FIG. 6 is a cross-sectional view illustrating a modification example of a recording head relating to embodiment 2; and

FIG. 7 is a schematic view illustrating a configuration of a recording apparatus according to an embodiment of the invention.

### DESCRIPTION OF EXEMPLARY EMBODIMENTS

Embodiments of the invention will be described in detail.

### Embodiment 1

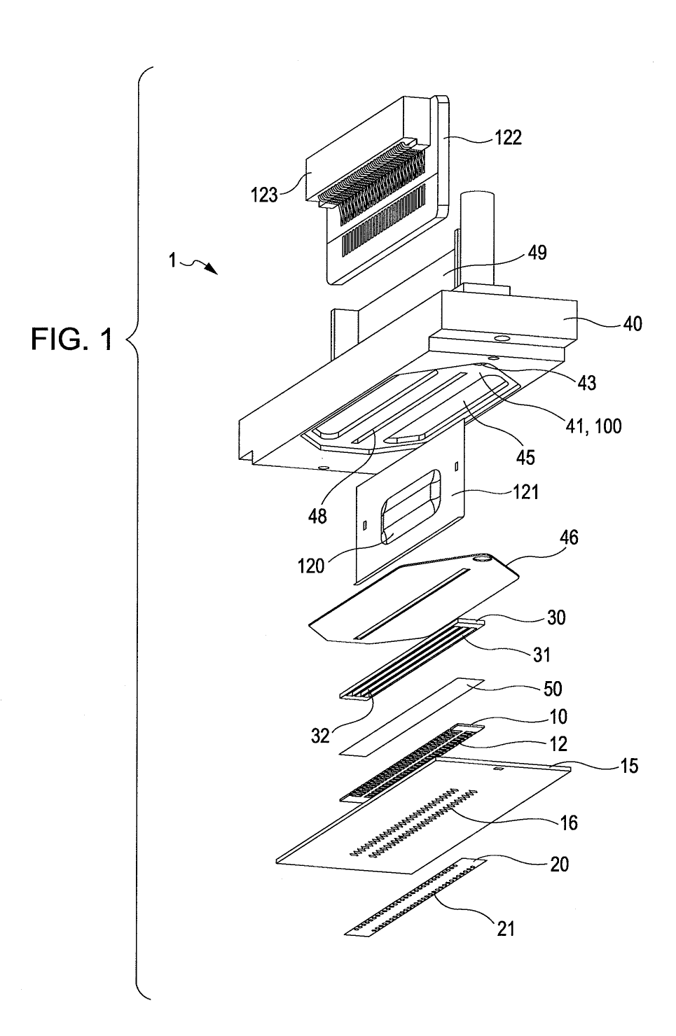

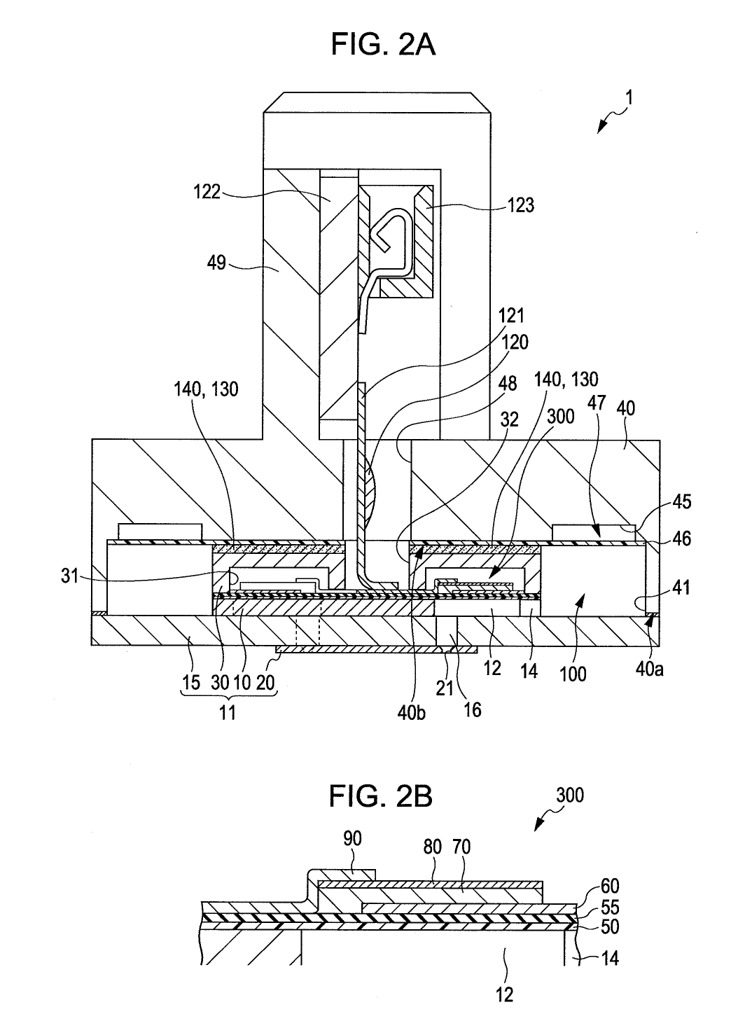

FIG. 1 is an exploded perspective view illustrating an ink jet recording head which shows an example of a liquid ejecting head relating to embodiment 1, and FIGS. 2A and 2B are cross-sectional view illustrating, in a longitudinal direction, a pressure generating chamber of an ink jet recording head.

As shown in drawings, an ink jet recording head 1 includes a plurality of members such as a head main body 11 and a case member 40, and the plurality of members is joined by an adhesive, and the like. In the present embodiment, the head main body 11 includes a flow channel forming substrate 10, that is, a flow channel forming member, a communication plate 15, a nozzle plate 20, and a protection substrate 30.

In the flow channel forming substrate 10, two rows in which a plurality of pressure generating chambers 12 is disposed in parallel in the width direction thereof are formed. Also, an ink supply path 14 is provided in an end side in the longitudinal direction of the pressure generating chamber 12 of the flow channel forming substrate 10. An elastic film 50 is formed in a side surface of the flow channel forming substrate 10, and a side surface of the pressure generating chamber 12 and the ink supply path 14 are constituted by the elastic film 50.

The communication plate 15 is joined to an open surface side (opposite of the elastic film 50) of the flow channel forming substrate 10. The nozzle plate 20 in which a plurality of nozzles 21 communicating with each of the plurality of pressure generating chambers 12 is bored is joined to the communication plate 15. A communication path 16 that connects the nozzle 21 to the pressure generating chamber 12 is provided in the communication plate 15. The communication plate 15 has a larger area than that of the flow channel forming substrate 10, and the nozzle plate 20 has a smaller than that of the flow channel forming substrate 10. In this manner, the area of the nozzle plate 20 is relatively smaller, thereby reducing costs. Also, in the present embodiment, the communication plate 15 constitutes a part of the nozzle plate 20.

On the elastic film 50 formed in the flow channel forming substrate 10, an insulation film 55 is further formed. On the insulation film 55, a piezoelectric actuator 300 (a pressure generating unit) including a first electrode 60, a piezoelectric layer 70, and a second electrode 80 is provided. In the present embodiment, the first electrode 60 acts as a common electrode common to a plurality of piezoelectric actuators 300, and the second electrode 80 acts as a separate electrode that is provided independently in each of the plurality of piezoelectric actuators 300. In addition, an end of a lead electrode 90 is respectively connected to the second electrode 80. A wiring substrate 121 in which a driving circuit 120 is provided is connected to the other end of the lead electrode 90.

A protection substrate 30 having substantially the same size as that of the flow channel forming substrate 10 is joined to a surface of the side of the piezoelectric actuator 300 of the flow channel forming substrate 10. The protection substrate 30 has a holding portion 31 that is a space for protecting the piezoelectric actuator 300. In addition, a through-hole 32 is provided in the protection substrate 30. In the other end side of the lead electrode 90, the other end side of the lead electrode 90 is extended to be exposed within the through-hole 32, and the lead electrode 90 and the wiring substrate 121 are electrically connected within the through-hole 32.

In addition, the case member 40 in which a manifold communicating with the plurality of pressure generating chambers 12 is defined together with the head main body 11 is fixed to the head main body 11 configured as above.

The case member 40 has substantially the same shape as that of the above described communication plate 15 on a plan view, is fixed to the protection substrate 30 by an adhesive, and is also fixed to the above described communication plate 15 by an adhesive. Specifically, the case member 40 has a recessed portion 41 having a depth by which the flow channel forming substrate 10 and the protection substrate 30 are received in the side of the protection substrate 30. The recessed portion 41 has an opening area larger than that of a surface joined to the flow channel forming substrate 10 of the protection substrate 30. An open surface of the recessed portion 41 is sealed by the communication plate 15 in a state in which the flow channel forming substrate 10, and the like are received in the recessed portion 41. Thus, in an outer peripheral portion of the flow channel forming substrate 10, the manifold 100 is defined by the case member 40 and the head main body 11.

In addition, in a bottom surface of the recessed portion 41 of the case member 40, a space portion 45 having a recessed shape is formed facing the manifold 100. In addition, in the bottom surface of the recessed portion 41 of the case member 40, a sealing film 46 is provided, so that the space portion 45 is sealed by the sealing film 46. Thus, a part of the side of the case member 40 of the manifold 100 is a flexible portion 47 capable of being flexibly deformable, which is sealed only by the sealing film 46.

However, the case member 40 is also adhered to the communication plate 15 together with the protection substrate 30 as described above. That is, the case member 40 includes a first surface 40a and a second surface 40b which have different heights. In the present embodiment, the first surface 40a of the case member 40 is adhered to the communication plate 15, and the second surface 40b in which the sealing film 46 is provided is adhered to the protection substrate 30. As shown in FIGS. 2A and 2B, an absorption member 140 that is made of an elastic material and absorbs an adhesive 130 is interposed between the second surface 40b of the case member 40 and the protection substrate 30. That is, the second surface 40b of the case member 40 and the protection substrate 30 are adhered and fixed by the adhesive 130 contained in the absorption member 140. As materials of the absorption member 140, for example, continuous foamed porous materials such as sponge, rubber, and the like may be suitably used, however, any material is possible as long as the material has elasticity and can absorb the adhesive 130.

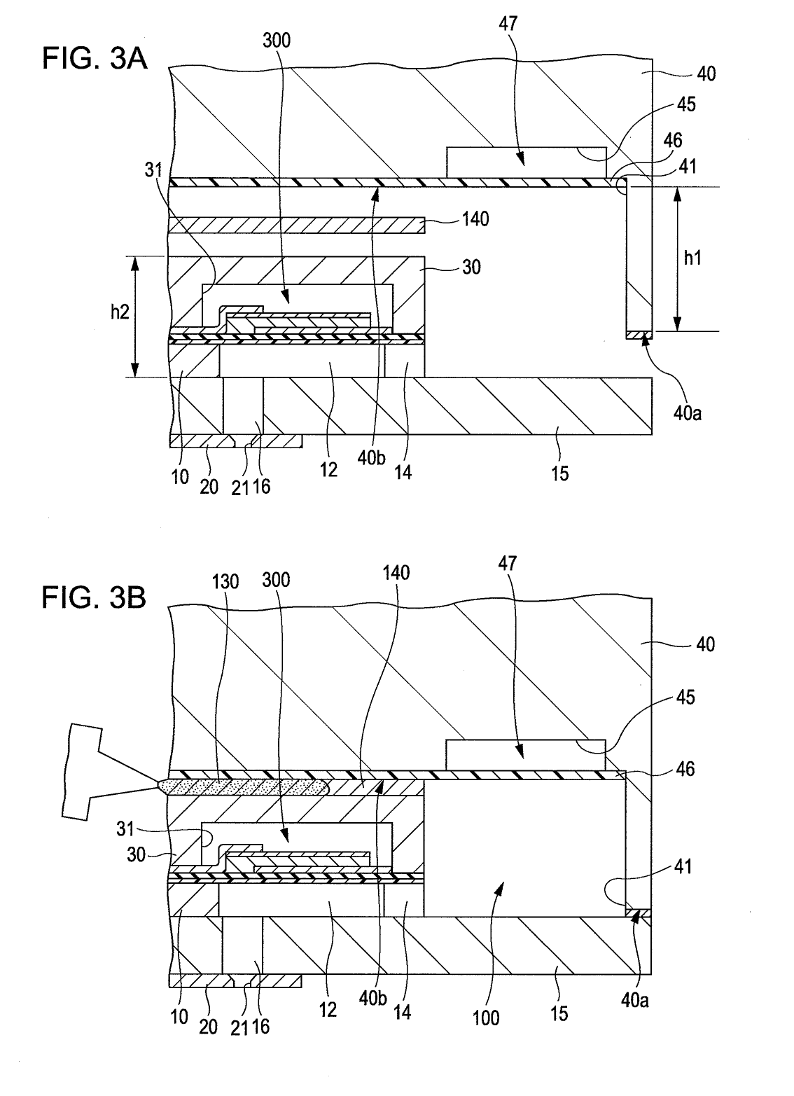

As a procedure of joining the head main body 11 and the case member 40, as shown in FIG. 3A, the first surface 40a of the case member 40 is coated with the adhesive 130, and the head main body 11 and the case member 40 abut on each other in a state in which the absorption member 140 is interposed between the second surface 40b of the case member 40 and the protection member 30.

Here, in the present embodiment, the depth of the recessed portion 41 of the case member 40, that is, a difference h1 in heights of the first surface 40a and the second surface 40b becomes slightly higher than a height h2 of the flow channel forming substrate 10 and the protection substrate 30 which constitute the head main body 11. Thus, when the case member 40 and the head main body 11 abut on each other, the first surface 40a actually abuts on the communication plate 15 through the adhesive 130. Meanwhile, the second surface 40b of the case member 40 and the protection substrate 30 do not actually abut on each other, and some gaps are formed therebetween. However, in the present embodiment, in a state in which the absorption member 140 is interposed between the case member 40 and the protection substrate 30, the head main body 11 and the case member 40 abut on each other. Thus, the absorption member 140 is interposed between the case member 40 and the protection substrate 30 in a state of being elastically deformed. That is, the gap between the case member 40 and the protection substrate 30 is sealed by the absorption member 140.

Thereafter, as schematically shown in FIG. 3B, a predetermined amount of the adhesive 130 is absorbed into the absorption member 140. Next, by curing the adhesive 130 absorbed into the absorption member 140, the case member 40 and the protection member 30 are adhesively fixed by the adhesive 130.

In this manner, the case member 40 and the protection member 30 are fixed by the adhesive 130 absorbed into the absorption member 140, so that it is possible to suppress joint defects due to a shortage of the adhesive, or flowing-in of excess adhesive into a flow channel, for example, the manifold 100.

The size of the gap between the case member 40 and the protection substrate 30 varies slightly depending on dimensional errors of the respective members, and the like. Thus, there is a possibility of joint defects occurring due to a shortage of the adhesive or flowing-in of excess adhesive into a flow channel when the second surface 40b of the case member 40 and the protection substrate 30 are adhered by the adhesive 130 without providing the absorption member 140 in the related art.

On the other hand, the absorption member 140 is interposed between the case member 40 and the protection substrate 30, and a desired amount of the adhesive 130 is absorbed into the absorption member 140, so that it is possible to suppress problems such as flowing out of the adhesive 130, and the like. Therefore, regardless of the dimensional errors of the respective members, it is possible to firmly adhere the case member 40 and the protection substrate 30 (the head main body 11) by the adhesive 130. For example, in the configuration of this example, since the second surface 40b of the case member 40 is in contact with the manifold 100, that is, a flow channel, the adhesive 130 easily flows into the manifold 100. However, by providing the absorption member 140, it is possible to suppress the flowing-in of the adhesive 130 into the flow channel even in the configuration of this example.

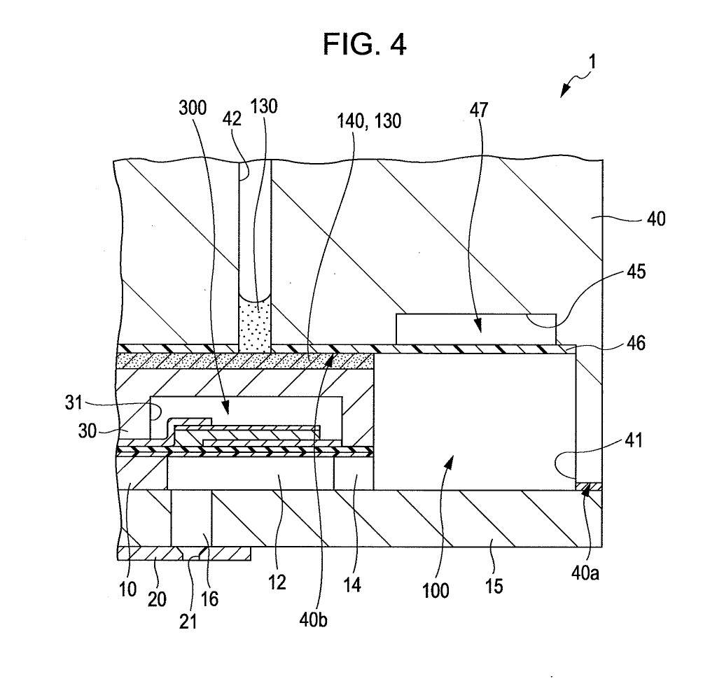

In addition, in the present embodiment, the adhesive 130 is absorbed into the absorption member 140 (FIGS. 3B) in the state in which the absorption member 140 is interposed between the case member 40 and the protection substrate 30, however, this method is not particularly limited. For example, as shown in FIG. 4, a through-hole 42 communicating with the second surface 40b may be provided in the case member 40, so that the adhesive 130 may be supplied to the absorption member 140 from the through-hole 42. In addition, obviously, the absorption member 140 that absorbs the adhesive 130 in advance may be interposed between the case member 40 and the protection substrate 30.

In any case, the case member 40 and the head main body 11 are fixed by the adhesive 130 that has been absorbed into the absorption member 140, so that it is possible to firmly fix the case member 40 and the head main body 11.

In addition, in the present embodiment, the absorption member 140 is provided over the entire surface of the protection substrate 30, however, the absorption member 140 is not always provided over the entire surface of the protection substrate 30, and may be provided in a part of the surface of the protection substrate 30. For example, the absorption member 140 may be provided only in an outer peripheral portion of the protection substrate 30 in a frame shape. Even in this configuration, obviously, it is possible to improve the adhesive strength between the case member 40 and the protection substrate 30 (the head main body 11).

In addition, in the present embodiment, as an example, the configuration in which the absorption member 140 is provided between the case member 40 and the head main body 11 has been described. However, obviously, the absorption member 140 may be provided between the case member 40 and the communication plate 15. Further, in the present embodiment, the recessed portion 41 of the case member 40 is sealed by the communication plate 15, however, the communication plate 15 may not be always provided. For example, the recessed portion 41 may be sealed by the nozzle plate 20, without providing the communication plate 15.

In addition, in the case member 40, an introducing passage 43 that communicates with the manifold 100 to supply ink to the manifold 100 is provided (see, FIG. 1). In addition, in the case member 40, a connection port 48 that communicates with the through-hole 32 of the protection substrate 30 to allow a wiring substrate 121 to be inserted therethrough is provided. Further, the case member 40 includes a wall portion 49 formed in an opening edge portion of the connection port 48. In the wall portion 49, the wiring substrate 121 and a connection substrate 122 connected to the wiring substrate 121 are fixed. The connection substrate 122 includes a rigid substrate in which a connector 123 connected to, for example, an external wiring is provided.

In the ink jet recording head 1 having the above described configuration, ink is first introduced through the introducing passage 43 from an ink cartridge, and the like, when the ink is ejected, and the inside of the flow channel is filled with the ink until reaching the nozzle 21 from the manifold 100. Thereafter, by applying voltage to each of the plurality of piezoelectric actuators 300 corresponding to the pressure generating chamber 12 depending on signals from the driving circuit 120, an elastic film 50 and an insulation film 55 are flexurally deformed together with the piezoelectric actuator 300. Thus, the pressure within the pressure generating chamber 12 is increased, so that ink droplets are ejected from a predetermined nozzle 21.

### Embodiment 2

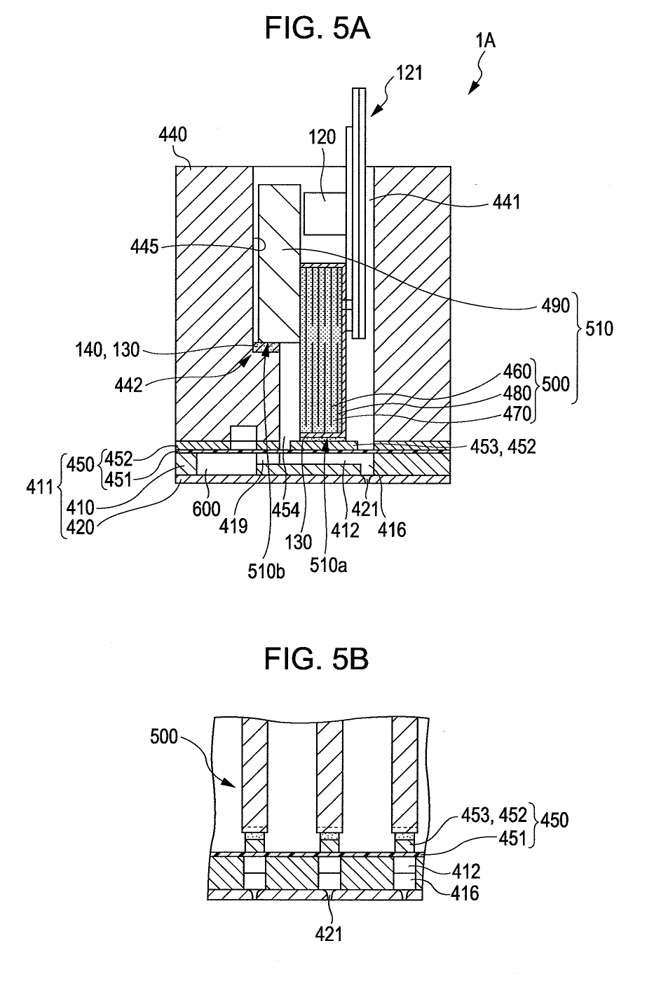

FIGS. 5A and 5B are cross-sectional view illustrating an ink jet recording head which is an example of a liquid ejecting head relating to embodiment 2.

As shown in FIGS. 5A and 5B, an ink jet recording head 1A of the present embodiment includes a head main body 411, a case member 440, and a piezoelectric actuator 500.

The head main body 411 includes a flow channel forming substrate 410 in which a plurality of pressure generating chambers 412 is formed, a nozzle plate 420 in which a plurality of nozzles 421 communicates with each of the plurality of pressure generating chambers 412 is bored, and a vibration plate 450 that is provided in the opposite surface of the nozzle plate 420 of the flow channel forming substrate 410.

In the flow channel forming substrate 410, each of the plurality of pressure generating chambers 412 is sectioned by partition walls to be juxtaposed in the width direction thereof. In addition, in one end side in the longitudinal direction of the pressure generating chamber 412 of the flow channel forming substrate 410, a manifold 600 is provided penetrating the flow channel forming substrate 410. Each of the plurality of pressure generating chambers 412 and the manifold 600 are respectively connected through an ink supply passage 419.

In addition, in the present embodiment, the pressure generating chamber 412 is formed without penetrating the flow channel forming substrate 410. In the opposite end portion of the manifold 600 of the pressure generating chamber 412, a communication passage 416 penetrating the flow channel forming substrate 410 is formed.

The nozzle plate 420 in which a plurality of nozzle 421 is bored is joined to one surface side of the flow channel forming substrate 410. Each of the plurality of nozzles 421 communicates with each of the plurality of pressure generating chambers 412 through the communication passage 416 provided in the flow channel forming substrate 410.

The vibration plate 450 is joined to the other surface side of the flow channel forming substrate 410, that is, an opening surface side of the pressure generating chamber 412, and one surface of the flow channel such as the pressure generating chamber 412, the manifold 600, or the like is sealed by the vibration plate 450.

The vibration plate 450 is formed of a composite plate of an elastic film 451 that is made of an elastic member, for example, a resin film, and the like, and a supporting plate 452 that supports the elastic film 451 and is made of, for example, a metal material, and the like. The elastic film 451 side is joined to the flow channel forming substrate 410. In addition, within a region facing each of the plurality of pressure generating chamber 412 of the vibration plate 450, a plurality of island portion 453 on which a tip of the piezoelectric actuator 500 abuts is provided. That is, a thin wall portion 454 that has a thinner thickness than those of other regions is formed in a region facing a periphery of each of the plurality of pressure generating chamber 412 of the vibration plate 450, and the island portions 453 are respectively provided in an inner side of the thin wall portion 454.

On the vibration plate 450, the piezoelectric actuator 500 is fixed in a state in which the tip of the piezoelectric actuator 500 abuts on each of the island portions 453. The piezoelectric actuator 500 constitutes a piezoelectric actuator unit 510, that is, a pressure generating unit in a manner such that a piezoelectric layer 470, and an individual internal electrode 480 and a common internal electrode 460 are alternately stacked, and an inactive region that does not contribute to the piezoelectric deformation is fixed to the fixing plate 490. In addition, a wiring substrate 121 in which the driving circuit 120 is mounted is connected to the inactive region of the piezoelectric actuator 500.

In addition, similar to the thin wall portion 454, a region facing the manifold 600 of the vibration plate 450 substantially includes only the elastic film 451 with the supporting plate 452 removed, and is thereby deformed by the pressure change within the manifold 600.

The case member 440 is fixed on the vibration plate 450, and includes a receiving unit 441 in which the piezoelectric actuator unit 510 is received. A step portion 442 to which the fixing plate 490 is locked when the piezoelectric actuator unit 510 is received is provided within the receiving unit 441. That is, in the present embodiment, the fixing plate 490 is joined to the step portion 442 of the case member 440 by the adhesive, so that the piezoelectric actuator unit 510 is fixed to the case member 440 in a state in which the tip of the piezoelectric actuator 500 abuts on the island portion 453 of the vibration plate 450.

As described above, in the present embodiment, the piezoelectric actuator unit 510 has a first surface 510a and a second surface 510b which have different heights. That is, the first surface 510a that is a tip surface of the piezoelectric actuator 500 is adhered to the island portion 453 of the vibration plate 450, and the second surface 510b that is a cross-section of the fixing plate 490 is fixed to the step portion 442 of the case member 440 by the adhesive.

Next, the absorption member 140, which is made of an elastic material and absorbs the adhesive 130, is interposed between the fixing plate 490 and the step portion 442 of the case member 440. That is, the fixing plate 490 and the step portion 442 of the case member 440 are adhered and fixed by the adhesive 130 contained in the absorption member 140.

Thus, as described in example 1, joint defects due to the shortage of the adhesive, and the like may be suppressed, and thereby satisfactorily and firmly join the piezoelectric actuator unit 510 and the case member 440.

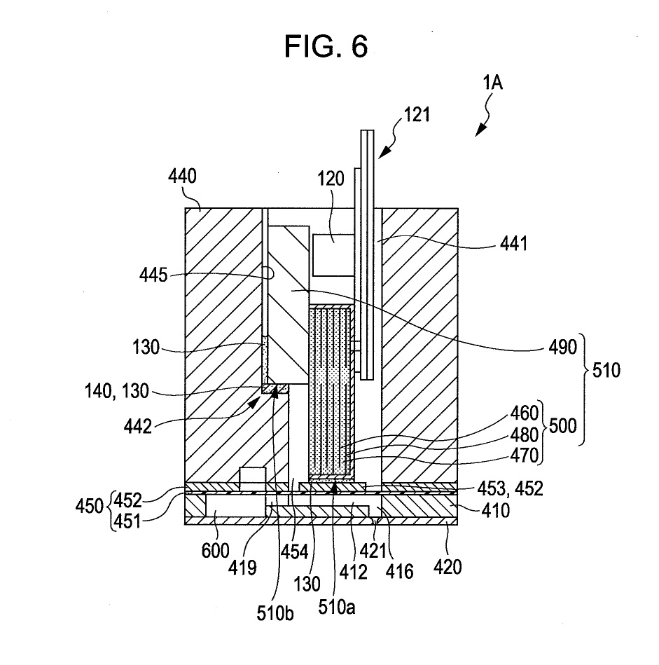

In addition, in the present embodiment, in the state in which the absorption member 140 is interposed between the fixing plate 490 and the step portion 442 of the case member 440, the adhesive 130 is absorbed into the absorption member 140 from a gap 445 between the opposite surface of the piezoelectric actuator 500 of the fixing plate 490 and the case member 440. In addition, in the present embodiment, the fixing plate 490 and the case member 440 are adhered and fixed only by the adhesive 130 absorbed into the absorption member 140. However, for example, as shown in FIG. 6, by absorbing the adhesive 130 into the absorption member 140, the gap 445 between the fixing plate 490 and the case member 440 may be further filled with the adhesive 130. Thus, it is possible to firmly join the piezoelectric actuator unit 510 by the case member 440.

### Another Embodiment

As described above, each of embodiments has been described; however, a basic configuration of the invention is not limited to the above described examples. For example, in the above described embodiment, an example in which a single member such as the case member, and the like, has the two surfaces (the first surface and the second surface) having different heights that are adhered to other members has been described. However, obviously, the invention may also be applied to a case in which a single member has three or more surfaces having different heights, which are adhered to the other members.

In addition, in each of the above described embodiments, as examples of the pressure generating unit that causes the pressure change in the pressure generating chamber, a thin-film piezoelectric actuator and a longitudinal vibration piezoelectric actuator have been given; however, the configuration of the pressure generating unit is not particularly limited. As the pressure generating unit, for example, a thick-film piezoelectric actuator, and the like that are formed by a method such as attaching a green sheet may be used. Further, as the pressure generating unit, a unit that ejects droplets from a nozzle by bubbles generated by heating of a heating element that is disposed within the pressure generating chamber, a unit that ejects droplets from the nozzle by deforming the vibration plate by electrostatic force caused between the vibration plate and the electrode, and the like may be used.

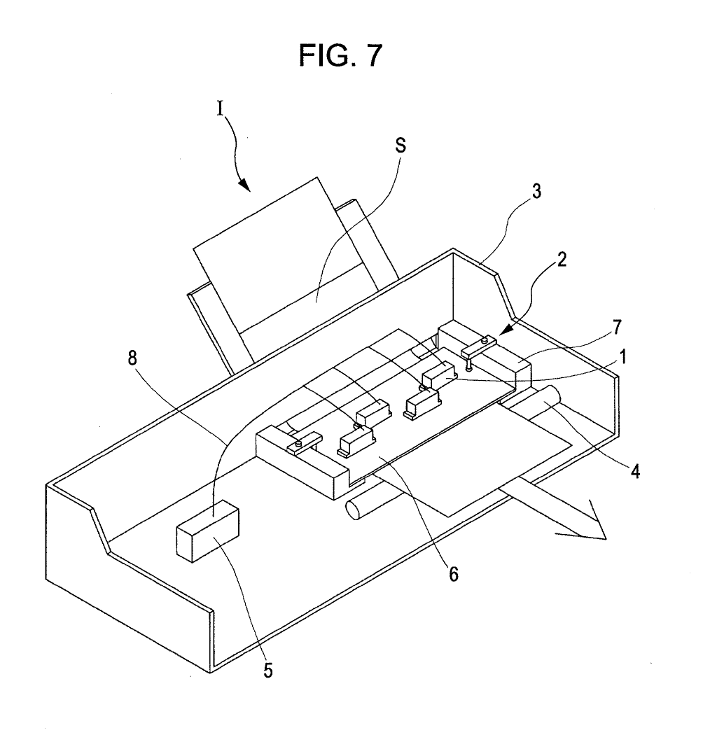

In addition, the above described ink jet recording head 1 constitutes a part of an ink jet recording head unit to thereby be mounted in an ink jet recording device. FIG. 7 is a schematic view illustrating an example of the ink jet recording apparatus.

The ink jet recording device of the present embodiment is a so-called line type device. As shown in FIG. 7, the ink jet recording device I includes an inkjet recording head unit 2 (hereinafter, referred to as a head unit 2) having the ink jet recording head 1, a device main body 3, a roller 4 for feeding a recording sheet S that is a medium to be recorded, and a liquid storage unit 5.

The head unit 2 includes a plurality of ink jet recording heads 1, and a base plate 6 that holds the plurality of ink jet recording heads 1. The head unit 2 is fixed to the device main body 3 through a frame member 7 that is mounted in the base plate 6.

The roller 4 is provided in the device main body 3, and transports the recording sheet S such as papers, and the like that are fed to the device main body 3, and pass through a nozzle surface side of the ink jet recording head 1 to thereby discharge the transported papers to the outside of the device.

The liquid storage unit 5 in which ink is stored is fixed to the device main body 3, and is connected to each of the plurality of ink jet recording heads 1 through a supply pipe 8 such as a flexible tube, and the like.

In the ink jet recording device I, when the ink is supplied to each of the plurality of ink jet recording head 1 through the supply pipe 8 from the liquid storage unit 5, and the recording sheet S is transported by the roller 4, ink is ejected from the ink jet recording head 1 of the head unit 2, so that an image, and the like is printed to the recording sheet S.

In addition, in the present embodiment, only one head unit 2 is mounted in the ink jet recording device I; however, the number of the head units 2 mounted in the ink jet recording device I is not particularly limited, and the multiple head units 2 may be provided.

In addition, the line type device has been described as the ink jet recording device; however, obviously, the ink jet recording device is not limited thereto. For example, even in a serial type ink jet recording device in which printing is performed while moving the ink jet recording head mounted in a carriage, the invention may be applied. In this case, the liquid storage unit may be mounted in the carriage together with the ink jet recording head.

Further, in the present embodiment, as an example of the liquid ejecting head, the ink jet recording head has been given and described according to the invention; however, the invention may be intended for a general liquid ejecting head, and general liquid ejecting apparatus including the same, and may be also applied to a liquid ejecting head that ejects liquid other than the ink, and a liquid ejecting apparatus including the same. As examples of the liquid ejecting head, various recording heads that are used in an image recording device such as a printer, and the like, a color material ejecting head that is used in manufacturing of a color filter such as a liquid crystal display, and the like, an electrode material ejecting head that is used in electrode formation of an EL organic display, an FED (field emission display), and the like, bioorganic ejecting head that is used in the manufacture of a biochip, and the like may be given.

What is claimed is:

1. A liquid ejecting head, comprising:
a head main body that includes a flow channel forming member in which a liquid flow channel having a pressure generating chamber communicating with a nozzle ejecting liquid is formed;
a pressure generating unit that is provided in an opposite surface side of the nozzle of the head main body, and generates a pressure change in liquid within the pressure generating chamber; and
a case member that is fixed in the opposite surface side of the nozzle of the head main body,
wherein any one from among the head main body, the pressure generating unit, and the case member is adhered to at least one other member, and has a first surface and a second surface in which a height of a joint surface in an ejection direction of the liquid is different,
the first surface is adhered to the other member, and
an absorption member that is made of an elastic material and absorbs an adhesive is interposed between the second surface and the other member.

2. The liquid ejecting head according to claim 1, wherein at least a part of a joint portion on the second surface is in contact with the liquid flow channel.

3. The liquid ejecting head according to claim 1, wherein
the head main body includes a flow channel forming substrate that has the pressure generating chamber, a nozzle plate that has the nozzle and is joined to one surface side of the flow channel forming member, and a protection substrate that is joined to another surface side of the flow channel forming substrate to protect the pressure generating unit provided on the flow channel forming substrate,
the case member includes the first surface adhered to the nozzle plate and the second surface adhered to the protection substrate, and
the absorption member is interposed between the case member and the protection substrate.

4. The liquid ejecting head according to claim 3, wherein, in the case member, a through hole that passes through the case member and opens on the second surface is provided.

5. The liquid ejecting head according to claim 1, wherein
the pressure generating unit includes a piezoelectric actuator of which a front end surface abuts on the head main body, and a fixing plate that is fixed to the case member while supporting a base end side of the piezoelectric actuator, and also includes the first surface in which the piezoelectric actuator is adhered to the head main body, and the second surface in which the fixing plate is adhered to the case member, and
the absorption member is interposed between the fixing plate and the case member.

6. A liquid ejecting apparatus which includes the liquid ejecting head according to claim 1.

7. A manufacturing method of a liquid ejecting head that includes a head main body that includes a flow channel forming member in which a liquid flow channel having a pressure generating chamber communicating with a nozzle ejecting liquid is formed, a pressure generating unit that generates a pressure change in liquid within the pressure generating chamber, and a case member that is fixed in the opposite surface side of the nozzle of the head main body, wherein any one from among the head main body, the pressure generating unit, and the case member is adhered to at least one other member, and has a first surface and a second surface in which a height of a joint surface in an ejection direction of the liquid is different, the manufacturing method, comprising:
abutting and adhering the first surface to the other member; and
adhering the second surface to the other member by disposing, in a gap between the second surface and the other member, an absorption member that is made of a material having elasticity and absorbing liquid, and by absorbing an adhesive using the absorption member.
